(19) United States
(12) Patent Application Publication
(10) Pub. No.: US 2023/0405518 A1
(43) Pub. Date: Dec. 21, 2023

(54) Packed Bed Non Thermal Plasma Photocatalytic Air Purification System

(71) Applicant: Daniel Arnold Janssen, Calgary (CA)

(72) Inventor: Daniel Arnold Janssen, Calgary (CA)

(21) Appl. No.: 18/100,078

(22) Filed: Feb. 27, 2023

Related U.S. Application Data
(63) Continuation of application No. 63/268,200, filed on Feb. 18, 2022.

(51) Int. Cl. B01D 53/32

(52) U.S. Cl. CPC B01D 53/323; B01D 2259/818; B01D 2255/9205

(57) ABSTRACT

This invention meets the need for low power consumption, high air flow rates, low noise while maintaining the highest efficacy in Volatile Organic Compound reduction, the total destruction of viruses, bacteria and unwanted pathogens with additional filtering mechanisms to remove particulate matter and potential Reactive Oxygen Species (ROS) byproducts. The inventions core sanitizing mechanism is a large diameter packed-bed non-thermal plasma reactor that uses high voltage to create a plasma field across a catalyst chamber filled with a proprietary nano porous pellet catalyst.

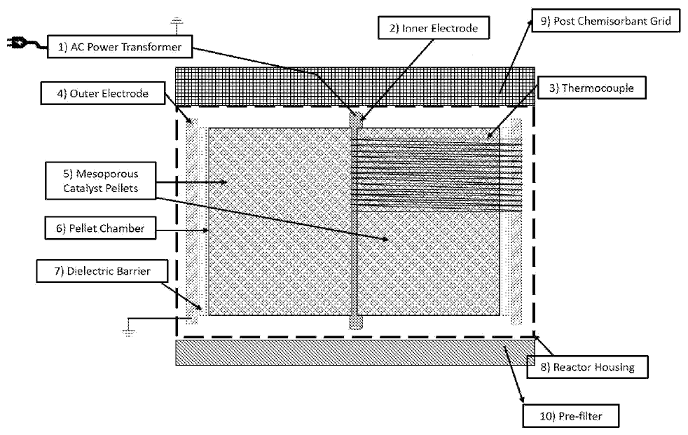

### FIELD OF INVENTION

With most people now spending 80% to 90% of their life in indoor environments, and our buildings becoming better sealed from outdoor air this may have important effects on human health, work efficiency and productivity. Indoor air quality (IAQ) has become a significant issue since the term “sick building syndrome” (SBS) was adopted by the World Health Organization in 1986.

SBS is a situation in which the occupants of a building experience acute health effects that seem to be linked to time spent in a building. SBS complaints are generally associated with headaches, eye, nose, or throat irritation, dry coughs, dry or itchy skin, dizziness, difficulty in concentrating, fatigue and multiple sensitivities. More importantly, most complainants report relief soon after leaving the building, suggesting that SBS complaints are due to the IAQ of the building.

IAQ problems range from outdoor air pollutants entering the building, off-gassing of chemicals known as Volatile Organic Compounds (VOCs) coming from building materials, equipment, solvents, cleaning supplies and many household goods. It is said that pollutants in our indoor environments are up to five times greater indoors than outdoors.

Particulate matter or atmospheric aerosol particles, which are particles ranging from PM10 (10 μm), to PM2.5 (2.5 μm) to ultra-fine particles below 0.1 μm have been widely studied in humans and linked to asthmas, lung cancer, respiratory diseases, cardiovascular disease, premature delivery, birth defects, low birth weight, developmental disorders, neurodegenerative disorders contributing to millions of premature deaths every year.

Now we have a heighten awareness of air borne viruses brought about from the recent COVID-19 pandemic that has further increased our awareness of IAQ and increased the demand for higher ventilation, better filtration and stand-alone air purifiers and electronic air cleaners (EAC's) to add further layers of protection for poorly ventilated spaces.

1: A Packed Bed Non Thermal Photocatalytic Air Purification System consisting of a reactor made from but not limited to metal alloys, glass or ceramic with an inner electrode, a dielectric barrier, and outer electrode.

2: The Packed Bed Non Thermal Photocatalytic Air Purification System is packed with a proprietary catalyst in the reactor discharge gap.

3: The Packed Bed Non Thermal Photocatalytic Air Purification System is capable of air flows up to, but not limited to 1400 Cubic Feet Per Minute.

4: The Packed Bed Non Thermal Plasma Air Purification System consists of, with or without a pre-filter and or a post-chemical absorbent media grid.
